(19) United States
(12) Patent Application Publication
(10) Pub. No.: US 2024/0135010 A1
(43) Pub. Date: Apr. 25, 2024

(54) METHOD FOR MANAGING ACCES BY A USER TO AT LEAST ONE APPLICATION, ASSOCIATED COMPUTER PROGRAM AND SYSTEM

(71) Applicant: BULL SAS, Les Clayes-sous-Bois (FR)

(72) Inventors: Christophe GUIONNEAU, GRENOBLE (FR); Emmanuel DE SAINT STEBAN, SAINT EGREVE (FR)

(73) Assignee: BULL SAS, Les Clayes-sous-Bois (FR)

(21) Appl. No.: 18/491,307

(22) Filed: Oct. 19, 2023

(30) Foreign Application Priority Data
Oct. 23, 2022 (EP) 22306611.9

(51) Int. Cl. G06F 21/60; G06F 21/31

(52) U.S. Cl. CPC G06F 21/604; G06F 21/31

(57) ABSTRACT

The invention relates to an access management method comprising, in response to a request to access a local application (23) hosted on a second network (10):
if the second network (10) is connected to a first network (8):
   receiving the access request by a master module (4) connected to the first network (8);
   determining, by the master module (4), access confirmation or denial data for access to the local application; and
   transmitting the determined access confirmation or denial data from the master module to the local application (23)
otherwise:
   receiving the access request by a satellite module (6) connected to the second network (10);
   determining, by the master module (6), access confirmation or denial data for access to the local application (23); and
   transmitting the determined access confirmation or denial data from the satellite module to the local application (23).

### TECHNICAL FIELD

The present invention relates to a method for managing the access by a user to at least one application.

The invention also relates to a computer program and a system each configured to implement such a method.

The invention applies to the field of managing the access by a user to an application hosted on a communication network.

### State of the Art

It is known to use identity providers implementing authentication mechanisms to allow users to access available resources on a network.

Such identity providers generally offer identity access management functions for the customized assignment of access rights to said resources based on the user or group of users.

Such resources are, for example, applications referred to as “As A Service” (or software as service) hosted on the Internet. According to another example, such resources are so-called applications referred to as “on-premises,” that is, hosted on a local communication network.

In the case of a local network, the identity provider is conventionally hosted within this network.

However, the identity provider is also likely to be externalized as an application “as a service,” for example in the cloud, as well as forming an identity management service as a service (IDAAS).

Such an IDAAS is advantageous in that it makes it possible to relieve the owners of the local network of the burden of managing user authentication.

Nevertheless, such an IDAAS is not entirely satisfactory.

Indeed, the IDAAS service being in the cloud, it requires a permanent and reliable connection between the local network and the Internet.

However, for operational reasons, the local network is likely to be partially or totally disconnected from the Internet, sometimes for long periods. This is, for example, the case if the local network is an internal network on a ship, for example a merchant ship. Now, even if a connection to the IDAAS in the cloud is not possible, users must continue to access the applications hosted on the local network, while respecting the access rights assigned to them. Furthermore, it may be necessary to modify the access rights when the local network is disconnected from the Internet, for example when the ship is at sea.

An IDAAS service is therefore not suitable in this case.

One purpose of the present invention is to mitigate this shortcoming.

Another aim of the invention is therefore to propose an access management system that benefits from the advantages of an IDAAS, and that, when the local network is disconnected from the Internet, allows:
users to access the applications hosted on the local network, in accordance with the access rights assigned to them; and
administrators to modify access rights.

### DISCLOSURE OF THE INVENTION

The invention proposes to achieve at least one of the aforementioned aims via a method for managing access of at least one user to at least one application,
the access management method implementing an access management master module connected to a first network and configured to store first authentication information of each user for each application, the method comprising, in response to an access request by the user, on a
user terminal connected to a second network distinct from the first network, to access a local application hosted on an application server connected to said second network:
   if the second network is connected to the first network:
      receiving the access request by the master module;
      determining, by the master module, based on the first authentication information, access confirmation or denial data for user access to the local application; and
      transmitting the determined access confirmation or denial data from the master module to the application server,
   otherwise:
      receiving the access request by a satellite module located in the second network and configured to store second authentication information of each user for each local application;
      determining, by the satellite module, based on the second authentication information, access confirmation or denial data for user access to the local application; and
      transmitting the determined access confirmation or denial data from the satellite module to the application server.

Indeed, by using the core satellite located on the second network, the authentication operations for local applications remain possible for users connected to said second network, even if the connection with the first network is lost. In other words, for authentication operations of users connected to the second network, and in the event the master module is inaccessible, the satellite module offers an IDAAS service, such that it remains possible to use the applications hosted on the application server connected to said second network.

Furthermore, the priority loading of the master module, when the second network is connected to the first network, offers the advantages of using a centralized IDAAS service. Among these advantages, it is possible to cite the implementation of the most recent, modifiable authentication information in a centralized manner by an administrator, or the use of the single sign-on (SSO) for all applications, whether hosted on the first network or on the second network.

According to other advantageous aspects of the invention, the method comprises one or more of the following features, considered alone or according to all technically possible combinations:
the access request is received by the master module from the satellite module;
the access confirmation or denial data determined by the master module are transmitted to the application server by the satellite module;
the access management method comprises, in response to an access request by the user, on the user terminal connected to the second network, to access a remote application hosted on an application server connected to the first network:
receiving the access request by the master module from the second network;
determining, by the master module, based on the first authentication information relative to the user, access confirmation or denial data for user access to the remote application; and
transmitting the determined access confirmation or denial data to the application server hosting the remote application;
the access management method further comprises, in response to an access request by the user, on the user terminal connected to the second network, to access an external application hosted on an application server connected to a third network distinct from the first network and the second network:
receiving the access request by the master module from the second network;
determining, by the master module, based on the first authentication information relative to the user, access confirmation or denial data for user access to the external application; and
transmitting the determined access confirmation or denial data from the master module to the application server hosting the external application;
the master module is configured to store harmonization rules, the satellite module being configured in order, upon a connection of the second network to the first network, to transmit the corresponding second authentication information to the master module, the master module further being configured to:
compare the received second authentication information to the current first authentication information;
depending on a result of the comparison and on the harmonization rules:
   update at least part of the first authentication information; and/or
   for at least one satellite module, issue update instructions for updating the second authentication information;
the master module is configured, in response to a command to modify the first authentication information, and when the modification relates to a local application hosted on an application server connected to the second network, to issue update instructions for updating the corresponding second authentication information;
the master module and the satellite module are configured to each display, to a user provided with specific rights, a respective management interface on the corresponding user terminal, the satellite module being further configured to redirect the user to the management interface of the master module if the second network is connected to the first network;
the master module and the satellite module are configured to communicate with one another by implementing an encryption protocol.

Furthermore, the invention relates to a computer program product comprising instructions which, when executed by computer, implement the steps of the method as defined above.

The computer program can be coded in any suitable computer language, for example in C, C++, JAVA, Python, etc.

Furthermore, the invention relates to a system for managing access of at least one user to at least one application, the access management system comprising:
an access management master module connected to a first network and configured to store first authentication information of each user for each application; and
an access management satellite module located in a second network distinct from the first network, and configured to store second authentication information of each user for each local application hosted on an application server connected to said second network,
   the master module and the satellite module being configured such that, in response to an access request by the user, on a user terminal connected to the second network, to access a local application:
if the second network is connected to the first network, the master module:
   receives the access request;
   determines, based on the first authentication information, access confirmation or denial data for user access to the local application; and
   transmits, to the application server, the determined access confirmation or denial data,
if the second network is not connected to the first network, the satellite module:
   receives the access request;
   determines, based on the second authentication information, access confirmation or denial data for user access to the local application; and
   transmits, to the application server, the determined access confirmation or denial data.

### BRIEF DESCRIPTION OF THE DRAWINGS

The invention will be better understood with the aid of the following description, given solely by way of non-limiting example and with reference to the accompanying drawings, wherein:

FIG. 1 is a schematic representation of an access management system according to the invention, in a situation where a first and a second communication network are connected to one another;

FIG. 2 is a schematic representation of the system of FIG. 1, in a situation where the second network is not connected to the first network;

FIG. 3 is a schematic representation of the system of FIG. 1, in a situation where a target application is hosted on the first communication network; and

FIG. 4 is a schematic representation of the system of FIG. 1, in a situation where a target application is hosted on a network distinct from the first network and the second network to which the user terminal is connected.

### DETAILED DESCRIPTION

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior state of the art. This selection comprises at least one preferably functional feature which lacks structural details, or only has a portion of the structural details if that portion only is sufficient to confer a technical benefit or to differentiate the invention with respect to the prior state of the art.

In the figures the same reference has been used for the elements that are common to several figures.

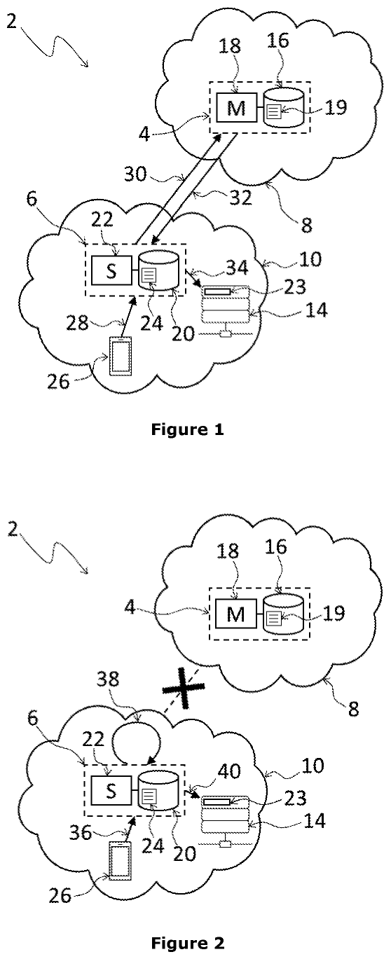

An access management system 2 according to the invention is shown by FIGS. 1 to 4.

The access management system 2 is intended to manage access to applications hosted on application servers connected to the Internet or to one or more local networks.

The access management system 2 comprises an access management master module 4 (also called “master module”), and at least one access management satellite module 6 (also called “satellite module”).

The master module 4 is connected to a first communication network 8, in particular connected to the Internet. Furthermore, the satellite module 6 is connected to a second communication network 10, such as a local network, for example a local network of a ship or a company.

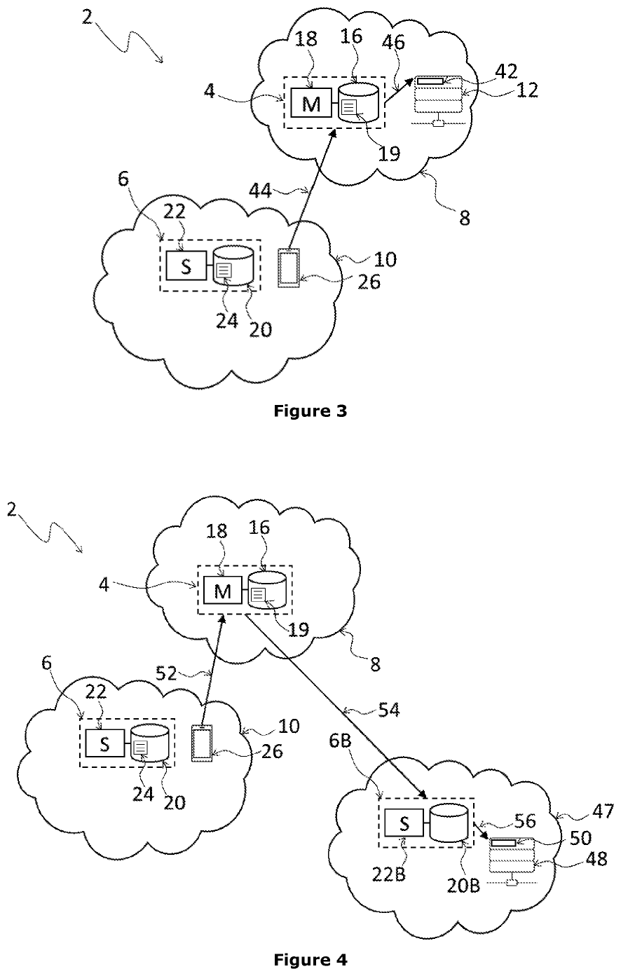

As shown in FIG. 3, a first application server 12 is preferably connected to the first network 8 is connected. Furthermore, a second application server 14 is connected to the second network 10.

A brief description of the master module 4 and of a satellite module 6 will now be provided, prior to a more detailed description of their configuration.

### Master Module 4

The master module 4 comprises a first memory 16 and a first control unit 18 which are connected to one another.

The first memory 16 is configured to store first authentication information.

Furthermore, the first control unit 18 is configured to determine access confirmation or denial data of each user for each application, based on the first authentication information stored in the first memory 16.

Such access confirmation or denial data have a format which depends on the chosen authentication protocol. For example, the access confirmation or denial data are as defined by the SAML (Security Assertion Markup Language) computer standard. According to another example, the access confirmation or denial data are as defined by the free protocol known as “OAuth,” or any other protocol or secure token allowing the transmission of proof of authentication of the user.

The first authentication information is representative of the entire configuration of the access management system 2, that is, relating to access to each application, whether it is hosted on the first application server 12 or the second application server 14.

Preferably, the first authentication information comprises a list 19 of users (and/or groups of users). Furthermore, for each application, each user is associated with at least one authentication method.

For example, such an authentication method is a smart card authentication (certificate defined by the X.509 standard), or a password authentication and OTP (one-time password) code generated by a mobile telephone application (without connection).

Preferably, the first authentication information is also representative of an authentication policy. The authentication policy is indicative of conditions for performing the user authentication. For example, the authentication policy comprises the following constraint: “user X is entitled to application Y if he is authenticated with method Z, in a time slot H, from IP address I.”

Advantageously, there are multiple authentication methods, and the authentication policy is chosen so that a user can authenticate himself in different scenarios and according to different authentication levels. By way of example, the authentication policy is sufficiently diversified to take into account authentications in connected mode (the user terminal is connected to the Internet and can, for example, receive authentication data provided by a server, called “push”) or in non-connected mode (the user terminal is not connected to the Internet and only one-time password authentication is possible).

More preferably, the first authentication information comprises system configuration data. Such configuration data comprises, in particular, parameters related to the applications, such as the name and/or description of the applications, application connection URLs, disconnection URLs (in particular in the case of Single Logout), or other information such as user attributes to be provided to each application, etc. Such information is, for example, intended to add the names/descriptions of local applications into a user's home interface (described later) or to perform a single logout of the user.

As mentioned above, the first control unit 18 is configured to determine the access confirmation or denial data of each user for each application. In particular, the first control unit 18 is configured to determine the access confirmation or denial data of each user for:
each application hosted on the first application server 12 connected to the first network 8; and/or
each application hosted on the second application server 14 connected to the second network 10, when the second network 10 is connected to the first network 8.

### Satellite Module 6

The satellite module 6 comprises a second memory 20 and a second control unit 22 which are connected to one another.

The second memory 20 is configured to store second authentication information relating to the access to each application hosted on the second application server 14 connected to the same second network 10 as the satellite module 6 (also called “local application 23”).

Preferably, the second authentication information comprises a sub-list 24 of the list 19 of users stored in the first memory 16. Furthermore, for each local application, each user of the sub-list 24 is associated with at least one authentication method.

Preferably, the second authentication information is also representative of an authentication policy. Such an authentication policy is indicative of conditions for performing the authentication of the users of the sub-list 24 for the local applications 23.

Also preferably, the second authentication information comprises configuration data comprising, in particular, parameters related to the local applications, such as the name and/or description of the local applications, local application connection URLs, disconnection URLs (in particular in the case of single logout), or other information such as user attributes to be provided to each local application, etc. Such information is, for example, intended to add the names/descriptions of local applications into a user's home interface (described later) or to perform a single logout of the user.

Advantageously, for harmonization, and as will be described later, the second authentication information is also stored in the first memory 16, preferably associated with a tag representative of the corresponding satellite module 6 and/or local application 23.

The second control unit 22 is configured to determine access confirmation or denial data of each user for each local application 23, based on the second authentication information stored in the second memory 20.

Preferably, the second control unit 22 is also configured to communicate with the first control unit 18.

Advantageously, the second control unit 22 and the first control unit 18 are configured to communicate with one another by implementing an encryption protocol, that is, a data encryption.

The implementation of such an encryption is advantageous, insofar as it ensures a continuity of security between the user and the target application.

For example, for each satellite module 6, a private key and a public key are defined by an administrator during an initialization of each satellite module 6. In this case, the private key and the public key are used for the encryption and the signature of data exchanged between the satellite module 6 and the master module 4.

According to another example, such an encryption relies on the implementation of a secure hypertext transfer protocol (or HTTPS, for HyperText Transfer Protocol Secure) and corresponding certificates.

Within the meaning of the present invention, “administrator” is understood to mean a user provided with specific rights, in particular administrator rights.

At least one of the master module 4 and the satellite module 6 is capable of being in hardware form, such as a computer, a server, a processor, an electronic chip, etc. Alternatively or additionally, at least one of the master module 4 and the satellite module 6 may be in software form, such as a computer program or an application, for example an application for a user apparatus like a tablet or smart phone.

Furthermore, at least one control unit 18, 22 is a hardware control unit, such as a processor, an electronic chip, a calculator, a computer, a server, etc. Alternatively or additionally, at least one control unit 18, 22 is a software control unit, such as an application, a computer program, a virtual machine, etc.

Other features of the access management system 2 will be better understood upon reading the following description, done with reference to FIGS. 1 to 4 in succession.

### Access to a Local Application: Second Network Connected to the First Network

FIG. 1 corresponds to a situation where the second network 10 is connected to the first network 8.

In the situation shown by FIG. 1, a user sends, via a user terminal 26 connected to the second network 10, a request to access a local application 23, hosted on the second application server 14 connected to said second network 10.

The master module 4 and the satellite module 6 are configured so that, in response to the user's access request, the first control unit 18 of the master module 4 receives the access request.

Advantageously, the second control unit 22 of the satellite module 6 is configured to first receive the access request sent from the user terminal 26 (arrow 28), and to transmit the received request to the master module 4 (arrow 30).

This is advantageous. Indeed, although the user terminal (generally a web browser) does not know the connection status of the second network with the master module 4, the satellite module 6 does know it. Furthermore, since the satellite module 6 is on the same second network as the user, the satellite module 6 is known and can be contacted at any time. Therefore, the satellite module 6 is able to perform or not perform a redirection to the master module 4, transparently for the user.

Furthermore, according to what has been described above, the first control unit 18 of the master module 4 is configured to determine, based on the first authentication information stored in the first memory 16, the user access confirmation or denial data for the local application 23. This is possible because the first authentication information relates to the access to each application, whether it is hosted on the first application server 12 or the second application server 14.

The first control unit 18 is also configured to transmit the determined access confirmation or denial data to the second application server 14.

Advantageously, the second control unit 22 of the satellite module 6 is configured to first receive the determined access confirmation or denial data transmitted by the master module 4 (arrow 32), and to transmit them to the second application server 14 (arrow 34).

The transmission of the access confirmation or denial data from the second control unit 22 of the satellite module 6 to the second application server 14 is advantageous, insofar as it authorizes configuring each local application to communicate with a single control unit, in this case the second control unit 22.

Access to a Local Application: Second Network Disconnected from the First Network

FIG. 2 corresponds to a situation where the second network 10 is not connected to the first network 8.

In the situation shown by FIG. 2, a user sends, via the user terminal 26 connected to the second network 10, a request to access a local application 23, hosted on the second application server 14 connected to said second network 10.

The satellite module 6 is configured so that, in response to the user's access request, and when the second network 10 is not connected to the first network 8, the second control unit 22 of the satellite module 6 receives the access request (arrow 36).

The second control unit 22 is configured, in this case, to determine access confirmation or denial data of the user for the local application 23, based on the second authentication information stored in the second memory 20 (arrow 38).

Furthermore, the second control unit 22 is configured to transmit the determined access confirmation or denial data which it has determined to the second application server 14 (arrow 40).

Preferably, when a connection is not established between the satellite module 6 and the master module 4, for example when the second network 10 has been disconnected from the first network 8, the second control unit 22 is configured to perform, successively over time, an attempt to connect to the master module 4.

This allows compliance with the conventional network security rules, which prohibit incoming connections (that is, coming from outside a local network), but allow outgoing connections (for example to the Internet) are allowed. In this way, the satellite modules 6 are able to reestablish a connection with the master module 4, ability which said master module 4 does not have.

### Accessing a Remote Application

FIG. 3 also corresponds to an advantageous operation of the access management system 2, in a situation where the second network 10 is connected to the first network 8.

In the situation shown by FIG. 3, a user sends, via the user terminal 26 connected to the second network 10, a request to access an application hosted on the first application server 12 connected to the first network 8, called remote application 42. From the user's point of view, such a remote application 42 is a SaaS application.

In this case, the master module 4 is configured to receive the access request from the second network 10, preferably directly from the user terminal 26 (arrow 44).

This is advantageous, insofar as the remote application is not configured to interact, with a view to authentication, with the satellite module 6 connected to the same network as the user terminal 26, but only with the master module 4.

Furthermore, the first control unit 18 of the master module 4 is configured to determine, based on the first authentication information relating to the user, the user access confirmation or denial data for the remote application 42.

The master module 4 is also configured to transmit the determined access confirmation or denial data to the first application server 12 hosting the remote application 42 (arrow 46).

### Access to an External Application

FIG. 4 also corresponds to an advantageous operation of the access management system 2, in a situation where the second network 10 is connected to the first network 8. Furthermore, a third remote network 47, distinct from the first network 8 and the second network 10, is also connected to the first network 8.

As shown in FIG. 4, a third application server 48 is connected to the third network 47, and hosts at least one application, called external application 50. Furthermore, an external satellite module 6B, similar to the satellite module 6 connected to the second network 10, is connected to the third network 47. The external satellite module 6B comprises a second memory 20B and a second control unit 22B in communication with one another.

In the situation shown in this FIG. 4, a user sends, via the user terminal 26 connected to the second network 10, an access request to access the external application 50 hosted on the third network 47.

In this case, the master module 4 is configured to receive the access request from the second network 10, preferably directly from the user terminal 26 (arrow 52).

This is advantageous, insofar as the external application is not configured to interact, with a view to authentication, with the satellite module 6 connected to the same network as the user terminal 26, but only with the master module 4.

Furthermore, the first control unit 18 of the master module 4 is configured to determine, based on the first authentication information relating to the user and stored in the first memory 16, the user access confirmation or denial data for the external application 50.

The first control unit 18 is also configured to transmit the determined access confirmation or denial data to the third application server 48.

Advantageously, the second control unit 22B of the external satellite module 6B is configured to first receive the determined access confirmation or denial data transmitted by the master module 4 (arrow 54), and to transmit the received access confirmation or denial data to the third application server 48 (arrow 56).

The transmission of the access confirmation or denial data from the second control unit 22B of the external satellite module 6B to the third application server 48 is advantageous, insofar as it authorizes configuring each external application 50 to communicate with a single control unit, in this case the second control unit 22B of the external satellite module 6B.

### Changes at the Master Module

Preferably, in addition to the determination of access confirmation or denial data, the master module 4 is also configured to control a modification of the second authentication information stored in each satellite module 6.

In particular, the master module 4 is able to receive a command to modify the first authentication information, for example from an administrator. Such a command is, for example, intended to modify user access rights to an application, or to modify a configuration of a satellite module. Such a command is also able to be used to initialize the access management system 2.

In this case, when the modification relates to authentication information associated with a tag corresponding to a satellite module 6 (for example a modification concerning a local application 23 hosted on the second application server 14 connected to the second network 10), the master module 4 is advantageously configured to deliver, to the satellite module 6, update instructions for updating the corresponding second authentication information.

This is advantageous, insofar as a modification of the second authentication information of each satellite module 6 may be carried out in a centralized manner, at the master module 4, which is configured to reflect said modifications to the appropriate satellite module(s) 6.

According to one embodiment, to perform such an update, the first control unit 18 is configured to determine whether the modification command relates to a satellite module 6, in particular based on the tags associated with the first information to be modified.

The first control unit 18 is also configured, if necessary, to generate update instructions for the appropriate satellite module 6. Such instructions comprise replacement values for all or part of the current second authentication information, and/or additional values completing the second authentication information stored in the second memory 20 of said satellite module.

Preferably, the update instructions are timestamped. The update instructions may also comprise a restart sequence, which is potentially required for the satellite module 6 to properly account for the modifications required by the update instructions.

In this case, the satellite module 6 is configured to apply the update instructions in the order of the time stamp, as well as the restart sequence. Such a time stamp is therefore advantageous, insofar as it authorizes the maintenance of an order even with several platforms (for example, several servers ensuring the redundancy of the master module).

### Changes to the Satellite Module

Preferably, the second control unit 22 is also configured, during the reestablishment of a connection between the second network 10 and the first network 8, to transmit all or part of the current second authentication information stored in the second memory 20 to the master module 4.

In particular, the second control unit 22 is configured to generate a queue containing the part of the second authentication information that has undergone modifications since the last disconnection between the second network 10 and the first network 8, and to transmit the queue to the master module 4.

Such modifications are changes made by an administrator (e.g. modifications to users' rights or passwords, modifications of the satellite module), or modifications made by a user himself (e.g. password or profile modifications). Such modifications may also comprise user connection logs (dates, sessions, errors, etc.).

Advantageously, the first memory 16 is also configured to store harmonization rules. Such harmonization rules are representative of a decision to be made in the event of disparities between the second authentication information of the queue received from the satellite module 6 and the corresponding part of the first authentication information stored in the master module.

The first control unit 18 is configured to compare the received second authentication information in the queue to the corresponding current first authentication information.

The first control unit 18 is also configured, depending on a result of the comparison and on the harmonization rules, to:
update at least part of the first authentication information; and/or
for at least one satellite module 6, issue update instructions for updating the second authentication information.

For example, if differences are detected after the comparison, the first control unit 18 is configured to determine, based on the harmonization rules, whether the different authentication information is to be kept, ignored or modified.

Regarding the information to be kept, the first control unit 18 is configured to write it into the first memory 16.

Regarding the information to be modified, the first control unit 18 is also configured to generate corresponding update instructions for the satellite module 6.

Such update instructions relate to replacement values for all or part of the second authentication information, or to new second authentication information.

Preferably, the update instructions are timestamped. The update instructions may also comprise a restart sequence, potentially required for the satellite module 6 to take the modifications into account.

In this case, the satellite module 6 is configured to apply update instructions in the order of the time stamp, as well as the restart sequence.

Such an operation is advantageous insofar as, in the time interval during which the second network 10 is not connected to the first network 8, an administrator is able to intervene at the corresponding satellite module 6 to modify the second authentication information stored in its second memory 20. Such modifications may conflict with the first authentication information stored at the master module. The implementation of such harmonization rules allows resolution of such conflicts.

Preferably, if during a reconnection of the second network 10 to the first network 8, the satellite module 6 receives update instructions while its queue is not empty (which corresponds to a situation where, in the time interval during which the second network 10 was not connected to the first network 8, modifications have been made both in the first authentication information of the master module and in the second authentication information of the satellite module 6), the satellite module 6 is configured to:
store the corresponding queue;
apply the update instructions received from the master module 4; and
transmit the stored queue to the master module 4.

In this case, the master module 4 is configured to implement the conflict resolution described above, based on the modified second authentication information in the queue received from the satellite module 6.

### Administrator Interface

Preferably, the master module 4 is configured to display, to an administrator, a respective management interface on the corresponding user terminal.

Preferably, the satellite module 6 is also configured to display, to a user provided with specific rights (in particular administrator rights), a respective management interface on the corresponding user terminal.

In this case, the satellite module 6 is further advantageously configured to redirect the user to the management interface of the master module if the second network is connected to the first network.

Each of these interfaces is, for example, a web interface.

In summary, the characteristic according to which the access request is received by the master module from the satellite module is advantageous insofar as the user terminal generally does not know the connection status of the second network with the master module 4, whereas the satellite module 6 does know it. Furthermore, since the satellite module 6 is on the same second network as the user, the satellite module 6 is known and can be contacted at any time. Therefore, the satellite module 6 is able to perform or not perform a redirection to the master module 4, transparently for the user.

The characteristic according to which the access confirmation or denial data determined by the master module are transmitted to the application server by the satellite module is advantageous, insofar as it authorizes a configuration of each local application so that it communicates with a single control unit, in this case the second control unit 22 of the satellite module 6 of the same network.

The invention, according to the embodiment described in relation to FIG. 3, is also advantageous insofar as it authorizes the user, on the user terminal connected to the second network, to access a remote application hosted on an application server connected to the first network.

The invention, according to the embodiment described in relation to FIG. 4, is also advantageous, insofar as it authorizes the user, on the user terminal connected to the second network, to access an external application hosted on an application server connected to a third network distinct from the first network and from the second network.

The characteristic according to which the master module is configured to store harmonization rules is advantageous, insofar as such harmonization rules allow the resolution of conflicts arising from any modifications to the second authentication information in a time interval during which the second network 10 is not connected to the first network 8.

The characteristic according to which the master module is configured, in response to a command to modify the first authentication information, to deliver update instructions for updating the second authentication information is advantageous, insofar as a modification of the second authentication information of each satellite module 6 may be carried out in a centralized manner, at the master module 4, which is configured to reflect said modifications to the appropriate satellite(s) module(s) 6.

The characteristic according to which the satellite module is configured to redirect the user to the management interface of the master module if the second network is connected to the first network is advantageous, insofar as it leads an administrator to make modifications to the second authentication information of each satellite module 6 in a centralized manner, at the master module 4.

The characteristic according to which the master module and the satellite module are configured to communicate with one another by implementing an encryption protocol is advantageous, insofar as it ensures a continuity of security between the user and the target application.

### Operation

The operation of the access management system 2 will now be described with reference to FIGS. 1 to 4.

During an initialization step, an administrator accesses the master module, via a dedicated administrator interface, and inputs the first authentication information.

This first authentication information relates to the configuration of the master module 4, as well as to all of the satellite modules 6 and the local 23, remote 42 and external 50 applications.

Then, depending on the first authentication information entered by the administrator, the master module 4 sends, to each satellite module 6, update instructions to update the corresponding second authentication information. In particular, in this step, such an update is an initialization.

Then, depending on the update instructions received, each satellite module 6 modifies (in this case initializes) the corresponding second authentication information.

Preferably, during such an initialization step, the administrator defines, for each satellite module 6, the previously mentioned private and public keys.

Once the access management system 2 is configured, a user sends a request to access an application via a user terminal 26 connected to the second network 10. For example, such a request is sent by selecting the application on a host interface accessible to the user through his user terminal 26.

By way of example, the satellite module 6 connected to said second network 10 proposes said host interface listing, for each user, the applications authorized to him and/or those that are reachable from the second network 10, based on the connection status of the second network to the first network 8.

Alternatively or additionally, the master module 4 proposes said host interface listing, for each user, the applications authorized to him and/or those which are reachable from the Internet, the SaaS applications and that of the various third networks depending on the connection status of the second network 10 to the first network 8.

If the user sends a request to access a local application 23, hosted on the second application server 14 connected to the second network 10, and if the second network 10 is connected to the first network 8, then the first control unit 18 of the master module 4 receives the access request.

Then, the first control unit 18 of the master module 4 determines, based on the first authentication information stored in the first memory 16, the user access confirmation or denial data for the local application 23.

Then, the first control unit 18 transmits the determined access confirmation or denial data to the second application server 14.

If the user sends a request to access a local application 23, hosted on the second application server 14 connected to the second network 10, and if the second network 10 is not connected to the first network 8, then the second control unit 22 of the satellite module 6 receives the access request.

Then, the second control unit 22 determines, based on the second authentication information stored in the second memory 20, the user access confirmation or denial data for the local application 23.

Then, the second control unit 22 transmits the access confirmation or denial data which it has determined to the second application server 14.

Preferably, as long as the second network 10 is not connected to the first network 8, the second control unit 22 generates a queue containing the modifications undergone by the second authentication information since the last disconnection between the second network 10 and the first network 8.

Preferably, when a connection is reestablished between the second network 10 and the first network 8, the second control unit 22 transmits all or part of the current second authentication information stored in the second memory 20 to the master module 4, in particular transmits the queue.

Then, the first control unit 18 compares the received second authentication information in the queue to the corresponding current first authentication information.

Then, depending on a result of the comparison and on the harmonization rules stored in the first memory 16, the first control unit 18:
updates at least part of the first authentication information; and/or
issues, to the satellite module 6, update instructions for updating the associated second authentication information.

Then, the satellite module 6 executes the received update instructions to modify the second information.

If the second network 10 is connected to the first network 8, and if the user sends a request to access a remote application 42 hosted on the first application server 12 connected to the first network 8, then the master module 4 receives the access request from the second network 10.

Then, the first control unit 18 of the master module 4 determines, based on the first authentication information relating to the user, the user access confirmation or denial data for the remote application 42.

Then, the master module 4 transmits the determined access confirmation or denial data to the first application server 12 hosting the remote application 42.

If the second network 10 is connected to the first network 8, and if the user sends a request to access a remote application 50 hosted on a third network 47, then the master module 4 receives the access request from the second network 10.

Furthermore, the first control unit 18 of the master module 4 determines, based on the first authentication information relating to the user, the user access confirmation or denial data for the external application 50.

Then, the first control unit 18 transmits the determined access confirmation or denial data to the third application server 48.

1. A method for managing access of at least one user to at least one application, the method for managing access implementing an access management master module connected to a first network and configured to store first authentication information of each user of said at least one user for each application of said at least one application, wherein, in response to an access request by the at least one user, on a user terminal connected to a second network distinct from the first network, to access a local application hosted on a first application server connected to said second network, the method comprising:
when the second network is connected to the first network,
receiving the access request by the access management master module;
determining, by the access management master module, based on the first authentication information, access confirmation or denial data for user access to the local application; and
transmitting the access confirmation or denial data that is determined from the access management master module to the first application server;
when the second network is not connected to the first network,
receiving the access request by a satellite module located in the second network and configured to store second authentication information of said each user for each local application;
determining, by the satellite module, based on the second authentication information, access confirmation or denial data for user access to the local application; and
transmitting the access confirmation or denial data that is determined from the satellite module to the first application server.

2. The method according to claim 1, wherein the access request is received by the access management master module from the satellite module.

3. The method according to claim 1, wherein the access confirmation or denial data that is determined by the access management master module is transmitted to the application server by the satellite module.

4. The method according to claim 1, further comprising, in response to an access request by the at least one user, on the user terminal connected to the second network, to access a remote application hosted on a second application server connected to the first network:
receiving the access request by the access management master module from the second network;
determining, by the access management master module, based on the first authentication information relative to the at least one user, access confirmation or denial data for user access to the remote application; and
transmitting the access confirmation or denial data that is determined to the second application server hosting the remote application.

5. The method according to claim 1, further comprising, in response to an access request by the at least one user, on the user terminal connected to the second network, to access an external application hosted on a third application server connected to a third network distinct from the first network and the second network:
receiving the access request by the access management master module from the second network;
determining, by the access management master module, based on the first authentication information relative to the at least one user, access confirmation or denial data for user access to the external application; and
transmitting the access confirmation or denial data that is determined from the access management master module to the third application server hosting the external application.

6. The method according to claim 1, wherein the access management master module is configured to store harmonization rules,
wherein the satellite module being configured, during a connection of the second network to the first network, to transmit the second authentication information to the access management master module;
compare the second authentication information that is received to the first authentication information that is current;
depending on a result of the compare and on the harmonization rules, one or more of:
update at least part of the first authentication information;
for at least one satellite module, issue update instructions for updating the second authentication information.

7. The method according to claim 1, wherein the access management master module is configured, in response to a command to modify the first authentication information, and when the command to modify relates to the local application hosted on the first application server connected to the second network, to issue update instructions for updating the second authentication information.

8. The method according to claim 1, wherein the access management master module and the satellite module are configured to each display, to a specific user provided with specific rights, a respective management interface on the user terminal associated with said specific user provided with specific rights, the satellite module being further configured to redirect the specific user to the respective management interface of the access management master module if the second network is connected to the first network.

9. The method according to claim 1, wherein the access management master module and the satellite module are configured to communicate with one another by implementing an encryption protocol.

10. A non-transitory computer program product comprising instructions which, when executed by a computer, implement a method for managing access of at least one user to at least one application, the method for managing access implementing an access management master module connected to a first network and configured to store first authentication information of each user of said at least one user for each application of said at least one application, wherein, in response to an access request by the at least one user, on a user terminal connected to a second network distinct from the first network, to access a local application hosted on a first application server connected to said second network, the method comprising:
when the second network is connected to the first network,
receiving the access request by the access management master module;
determining, by the access management master module, based on the first authentication information, access confirmation or denial data for user access to the local application; and
transmitting the access confirmation or denial data that is determined from the access management master module to the first application server;
when the second network is not connected to the first network,
receiving the access request by a satellite module located in the second network and configured to store second authentication information of said each user for each local application;
determining, by the satellite module, based on the second authentication information, access confirmation or denial data for user access to the local application; and
transmitting the access confirmation or denial data that is determined from the satellite module to the first application server.

11. A system that manages access of at least one user to at least one application, the system comprising:
an access management master module connected to a first network and configured to store first authentication information of each user of said at least one user for each application of said at least one application; and
an access management satellite module located in a second network distinct from the first network, and configured to store second authentication information of said each user for each local application hosted on an application server connected to said second network,
wherein the access management master module and the access management satellite module are configured such that, in response to an access request by the at least one user, on a user terminal connected to the second network, to access a local application,
when the second network is connected to the first network, the access management master module
receives the access request;
determines, based on the first authentication information, access confirmation or denial data for user access to the local application; and
transmits, to the application server, the access confirmation or denial data that is determined,
when the second network is not connected to the first network, the access management satellite module
receives the access request;
determines, based on the second authentication information, access confirmation or denial data for user access to the local application; and
transmits, to the application server, the access confirmation or denial data that is determined.
